(19) United States
(12) Patent Application Publication
(10) Pub. No.: US 2026/0341617 A1
(43) Pub. Date: Oct. 29, 2026

(54) ELECTROMAGNETIC RELAY

(71) Applicant: Panasonic Intellectual Property Management Co., Ltd., Osaka (JP)

(72) Inventors: Masato NAKAMURA, Hyogo (JP); Kenji KANEMATSU, Osaka (JP); Shinya KIMOTO, Osaka (JP)

(21) Appl. No.: 19/101,525

(22) PCT Filed: Jan. 23, 2024
(86) PCT No.: PCT/JP2024/001753

§ 371 Date: Feb. 5, 2025

Related U.S. Application Data
(60) Provisional application No. 63/440,712, filed on Jan. 24, 2023.

(51) Int. Cl. H01H 50/12; H01H 50/02

(52) U.S. Cl. CPC H01H 50/12; H01H 50/023

(57) ABSTRACT

An electromagnetic relay includes a fixed terminal, a moving armature, an inner shell, a yoke, an outer shell, and a first filling material. The moving armature is arranged under the fixed terminal to contact with the fixed terminal. The inner shell houses the moving armature inside. A lower surface of the inner shell has an opening. The yoke is arranged under the inner shell to close the opening of the inner shell. The outer shell houses the inner shell inside. The first filling material is arranged to fill a gap space between the inner shell and the outer shell. The first filling material fills the gap space to a level higher than a lower surface of the yoke.

### TECHNICAL FIELD

The present disclosure generally relates to an electromagnetic relay, and more particularly relates to an electromagnetic relay including a shell filled with a filling material.

### BACKGROUND ART

An electromagnetic relay, including a coil, a yoke, a moving armature, a fixed contactor, and other members housed in an outer shell, has been known in the art. In such an electromagnetic relay, the outer shell thereof is sometimes filled with a filling material for bonding, protection, insulation, and other purposes.

Such an electromagnetic relay sometimes causes some inconvenience when the temperature of the filling material is caused to increase too much by the heat generated inside the outer shell.

### CITATION LIST

### Patent Literature

Patent Literature 1: JP 2022-170571 A

### SUMMARY OF INVENTION

An object of the present disclosure is to provide an electromagnetic relay having the ability to reduce an increase in the temperature of the filling material that fills the space inside its outer shell.

An electromagnetic relay according to an aspect of the present disclosure includes a fixed terminal, a moving armature, an inner shell, a yoke, an outer shell, and a first filling material. The moving armature is arranged under the fixed terminal to contact with the fixed terminal. The inner shell houses the moving armature inside. A lower surface of the inner shell has an opening. The yoke is arranged under the inner shell to close the opening of the inner shell. The outer shell houses the inner shell inside. The first filling material is arranged to fill a gap space between the inner shell and the outer shell. The first filling material fills the gap space to a level higher than surface of the yoke.

### BRIEF DESCRIPTION OF DRAWINGS

FIG. 1 is a schematic cross-sectional view illustrating an electromagnetic relay according to a first embodiment;

FIG. 2 is a perspective view of the electromagnetic relay;

FIG. 3 is a cross-sectional view of the electromagnetic relay;

FIG. 4 is another cross-sectional view of the electromagnetic relay;

FIG. 5 is a perspective view illustrating the appearance of the electromagnetic relay with an outer shell thereof partially removed;

FIG. 6 is a schematic cross-sectional view illustrating an electromagnetic relay according to a second embodiment;

FIG. 7 is a cross-sectional view of the electromagnetic relay;

FIG. 8 is a schematic cross-sectional view illustrating an electromagnetic relay according to a third embodiment; and

FIG. 9 is a cross-sectional view illustrating an electromagnetic relay according to a fourth embodiment.

### DESCRIPTION OF EMBODIMENTS

The present disclosure generally relates to an electromagnetic relay, and more particularly relates to an electromagnetic relay including a shell filled with a filling material.

Note that the embodiments to be described below are only exemplary ones of various embodiments of the present disclosure and should not be construed as limiting. Rather, the exemplary embodiments may be readily modified in various manners depending on a design choice or any other factor without departing from the scope of the present disclosure. In the following description, the first, second, and third directions D1, D2, D3 indicated by the arrows on the drawings are defined to be an upward/downward direction, a rightward/leftward direction, and a forward/backward direction, respectively, with respect to electromagnetic relays A1-A4. Note that the upward/downward direction, the rightward/leftward direction, and the forward/backward direction will be used in the following description just for the sake of convenience to help the reader understand the following description of embodiments fully and should not be construed as limiting the directions in which the electromagnetic relay A1-A4 is actually used. In addition, those arrows indicating the directions D1, D2, D3 on the drawings are just shown there for the purpose of description and are all insubstantial ones.

### First Embodiment

### (1) Overview

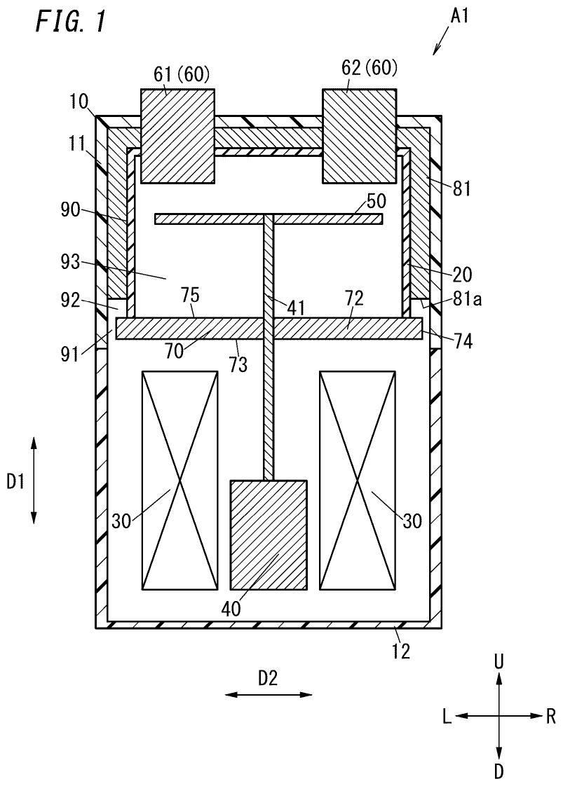

First of all, an overview of an electromagnetic relay A1 according to a first embodiment will be described with reference to FIG. 1.

The electromagnetic relay A1 includes a plurality of (e.g., two in the example illustrated in FIG. 1) fixed terminals 60, a moving armature 50, an inner shell 20, a yoke 70, an outer shell 10, and a first filling material 81. The moving armature 50 is arranged under the fixed terminals 60 to contact with the fixed terminals 60. The inner shell 20 houses the moving armature 50 inside and has an opening through a lower surface thereof. The yoke 70 is arranged under the inner shell 20 to close the opening of the inner shell 20. The outer shell 10 houses the inner shell 20 inside. The first filling material 81 is arranged to fill a gap space between the inner shell 20 and the outer shell 10. The first filling material 81 fills the gap space to a level higher than a lower surface 73 of the yoke 70.

In this electromagnetic relay A1, the first filling material 81 fills the gap space to a level higher than the lower surface 73 of the yoke 70, thus reducing the transfer of the heat generated by the yoke 70 to the first filling material 81 and thereby reducing an increase in the temperature of the first filling material 81 that fills the gap space inside the outer shell 10. This allows the electromagnetic relay A1 to efficiently transfer the heat of the inner shell 20 to the first filling material 81.

### (2) Details

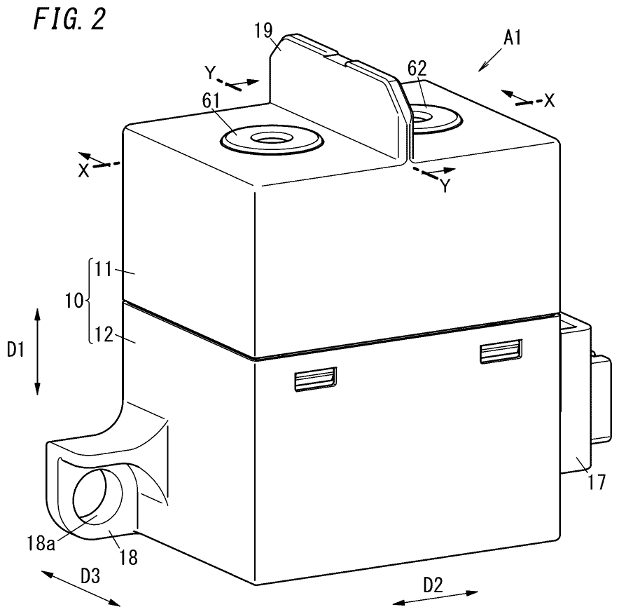

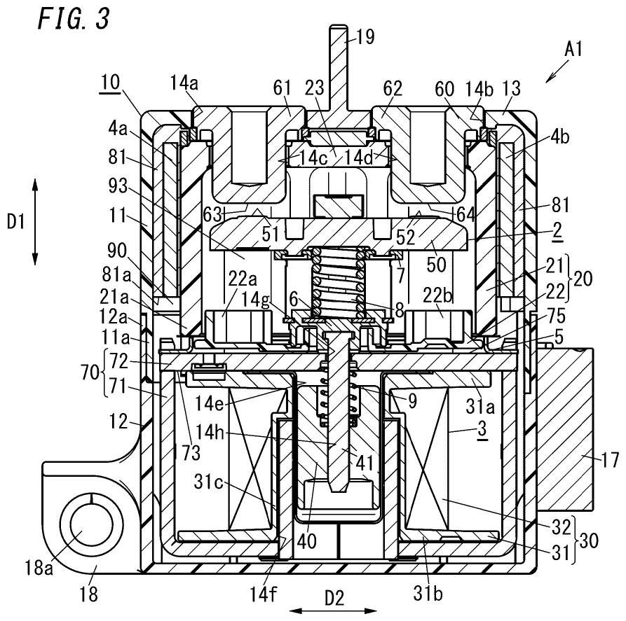

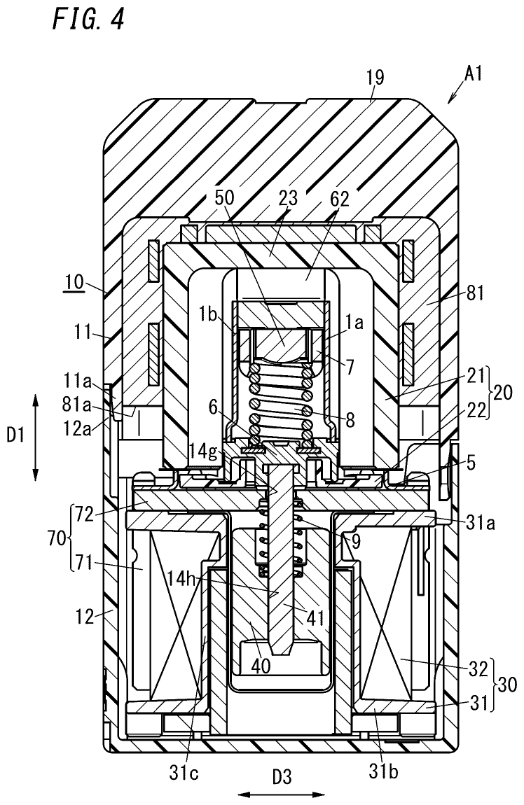

Next, the electromagnetic relay A1 according to the first embodiment will be described in detail with reference to FIGS. 1-5. FIG. 2 is a perspective view of the electromagnetic relay. FIG. 3 is a cross-sectional view thereof taken along the plane X-X shown in FIG. 2. FIG. 4 is a cross-sectional view thereof taken along the plane Y-Y shown in FIG. 2.

The electromagnetic relay A1 includes the outer shell 10, the inner shell 20, a coil 30, a moving iron core 40, the yoke 70, a shaft 41, the moving armature 50, the plurality of fixed terminals 60, and the first filling material 81. The plurality of fixed terminals 60 includes a first fixed terminal 61 and a second fixed terminal 62. The electromagnetic relay A1 further includes a pair of permanent magnets 4a, 4b, a coupling portion 5, a spring bearing 6, a holder 7, a contact pressure spring 8, and a return spring 9. At least the inner shell 20, the moving armature 50, and the fixed terminals 60 form a contact device 2. At least the coil 30, the moving iron core 40, and the yoke 70 form an electromagnet device 3.

The outer shell 10 has the shape of a hollow box (e.g., a rectangular parallelepiped box). The outer shell 10 includes an upper shell 11 and a lower shell 12. The upper shell 11 has the shape of a rectangular parallelepiped box, of which the lower surface is open. The upper shell 11 is arranged to cover the inner shell 20. A ceiling portion 13 of the upper shell 11 has a first through hole 14a and a second through hole 14b. The first through hole 14a is arranged to allow the first fixed terminal 61 inserted thereto to pass therethrough. The second through hole 14b is arranged to allow the second fixed terminal 62 inserted thereto to pass therethrough. The lower shell 12 has the shape of a rectangular parallelepiped box, of which the upper surface is open. The lower shell 12 is disposed under the upper shell 11. A lower end portion 11a of the upper shell 11 is fitted into an upper end portion 12a of the lower shell 12. Inside the outer shell 10, arranged are the inner shell 20, the coil 30, the moving iron core 40, the yoke 70, the shaft 41, the moving armature 50, the fixed terminals 60, the permanent magnets 4a, 4b, the coupling portion 5, the spring bearing 6, the holder 7, the contact pressure spring 8, and the return spring 9.

The upper shell 11 includes a wall portion 19 as shown in FIG. 2. The wall portion 19 has the shape of a plate (such as a rectangular plate). The wall portion 19 is interposed between the pair of fixed terminals 61, 62 on the upper surface of the upper shell 11. In other words, the wall portion 19 is interposed between the first through hole 14a and the second through hole 14b on the upper surface of the upper shell 11 (refer to FIG. 3). The wall portion 19 is provided to ensure an insulation distance (creepage distance) between the first fixed terminal 61 and the second fixed terminal 62.

The lower shell 12 includes a mounting portion 18 as shown in FIG. 3. The mounting portion 18 is configured to allow the electromagnetic relay A1 to be mounted at an installation place. The mounting portion 18 has a hole 18a. The hole 18a allows a screw (not shown) inserted thereto to pass therethrough.

The coil 30 and the moving iron core 40 are housed inside the lower shell 12 (that forms the lower part of the outer shell 10). The coil 30 is used to bring the moving armature 50 into, and out of, contact with the first fixed terminal 61 and the second fixed terminal 62. The coil 30 includes a coil bobbin 31 and an electric wire 32.

The coil bobbin 31 includes an upper brim portion 31a, a lower brim portion 31b, and a cylindrical portion 31c. The coil bobbin 31 may be made of a material with electrical insulation properties (such as a resin). The upper brim portion 31a has the shape of a plate (such as a disklike plate). A third through hole 14e is provided through a central portion of the upper brim portion 31a. The lower brim portion 31b has the shape of a plate (such as a disklike plate). A fourth through hole 14f is provided through a central portion of the lower brim portion 31b. The cylindrical portion 31c has the shape of a hollow cylinder (such as hollow circular cylinder). The outside diameter of the upper brim portion 31a is smaller than the outside diameter of the lower brim portion 31b. The outside diameter of the cylindrical portion 31c is smaller than the outside diameters of the upper brim portion 31a and the lower brim portion 31b. The outside diameter of an upper part of the cylindrical portion 31c is smaller than the outside diameter of a middle part or a lower part of the cylindrical portion 31c. The inside diameter of the third through hole 14e of the upper brim portion 31a is equal to the inside diameter of the upper part of the cylindrical portion 31c. The inside diameter of the fourth through hole 14f of the lower brim portion 31b is equal to the inside diameter of the lower part of the cylindrical portion 31c.

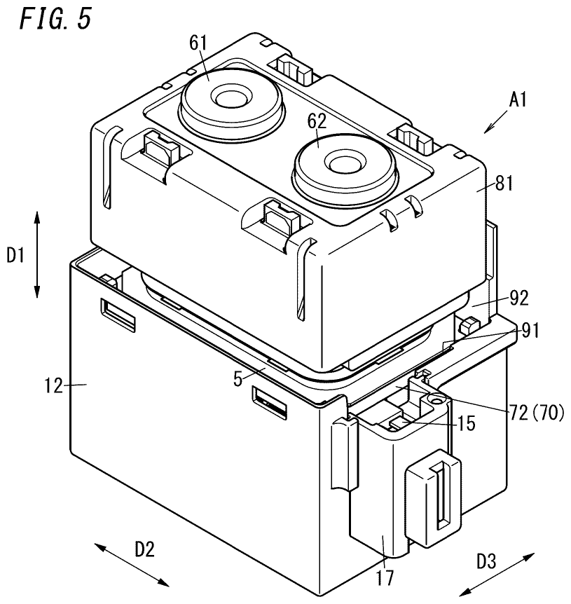

The electric wire 32 is wound around the outer periphery of the cylindrical portion 31c of the coil bobbin 31. A first end of the electric wire 32 is electrically connected to a first coil terminal 15 (refer to FIG. 5). A second end of the electric wire 32 is electrically connected to a second coil terminal (not shown). A material (such as copper) for the first coil terminal 15 and the second coil terminal has electrical conductivity. The first coil terminal 15 and the second coil terminal are housed inside a connecting portion 17 of the lower shell 12 of the outer shell 10 as shown in FIG. 5.

As shown in FIG. 3, the moving iron core 40 is housed inside the cylindrical portion 31c of the coil bobbin 31. The coil 30 and the moving iron core 40 are arranged inside the yoke 70.

The yoke 70 includes a lower yoke 71 and an upper yoke 72. A material for the yoke 70 is a magnetic material (such as light gauge steel). The yoke 70 includes at least the upper yoke 72.

The lower yoke 71 has the shape of a box (such as a rectangular parallelepiped box), of which the upper surface is open. Inside the lower yoke 71, arranged are the coil 30 and the moving iron core 40. The upper yoke 72 has the shape of a plate (such as a rectangular plate). The upper yoke 72 has a fifth through hole 14g. The fifth through hole 14g allows the shaft 41 inserted thereto to pass therethrough. The center axis of the fifth through hole 14g is aligned with the center axis of the cylindrical portion 31c of the coil bobbin 31. The upper yoke 72 is attached to the lower yoke 71 to close the opening of the lower yoke 71. The yoke 70 is housed inside the outer shell 10 such that the lower surface of the lower yoke 71 faces an inner bottom surface of the lower shell 12 of the outer shell 10 and that the upper surface 75 of the upper yoke 72 faces the top surface (i.e., the lower surface of the ceiling portion 13) of the upper shell 11 of the outer shell 10. In this embodiment, the yoke 70 serves, along with the moving iron core 40, as a magnetic circuit. The coil 30, the moving iron core 40, and the yoke 70 serve as either the electromagnet device 3 or a part of the electromagnet device 3. The coil 30 has the capability of generating a magnetic field when energized. The coil 30 causes the moving iron core 40 to move either upward or downward along the axis of the cylindrical portion 31c of the coil bobbin 31 (i.e., in the first direction D1) depending on whether any magnetic field is generated and the direction of the magnetic field if any.

The moving iron core 40 moves upward when the coil 30 is energized. On the other hand, the moving iron core 40 moves downward when the coil 30 is not energized. The moving iron core 40 has the shape of a hollow cylinder (e.g., a hollow circular cylinder). A material for the moving iron core 40 is a magnetic material (such as light gauge steel). The moving iron core 40 is disposed inside the coil 30. More specifically, the moving iron core 40 is disposed inside the cylindrical portion 31c of the coil bobbin 31. The moving iron core 40 has a sixth through hole 14h. The sixth through hole 14h allows the shaft 41 inserted thereto to pass therethrough. The center axis of the sixth through hole 14h is aligned with the center axis of the cylindrical portion 31c of the coil bobbin 31.

The inner shell 20 includes a first shell 21 and a second shell 22. A material for the inner shell 20 is a material with heat resistance (such as a ceramic). The inner shell 20 includes at least the first shell 21.

The first shell 21 has the shape of rectangular parallelepiped box, of which the lower surface is open (i.e., which has an opening through the lower surface thereof). The second shell 22 has the shape of a plate (such as a rectangular plate shape). A ceiling portion 23 of the first shell 21 has a seventh through hole 14c and an eighth through hole 14d. The seventh through hole 14c allows the first fixed terminal 61 inserted thereto to pass therethrough. The eighth through hole 14d allows the second fixed terminal 62 inserted thereto to pass therethrough. The second shell 22 includes a first protruding portion 22a and a second protruding portion 22b. The first protruding portion 22a is provided on the upper surface of the second shell 22 to be located on a left part of the inner shell 20 in the rightward/leftward direction (i.e., in the second direction D2). The second protruding portion 22b is provided on the upper surface of the second shell 22 to be located on a right part of the inner shell 20 in the rightward/leftward direction. The second shell 22 is arranged to close the opening of the first shell 21. In addition, the second shell 22 is disposed on the upper surface 75 of the upper yoke 72 of the yoke 70. The inner shell 20 is housed inside the upper shell 11 of the outer shell 10.

A gap space 90 is defined between the outer surfaces (i.e., the upper and outer peripheral surfaces) of the first shell 21 of the inner shell 20 and the inner surfaces (i.e., the top and inner peripheral surfaces) of (the upper shell 11 of) the outer shell 10. That is to say, the outer surfaces of the first shell 21 of the inner shell 20 and the inner surfaces of the upper shell 11 of the outer shell 10 face each other with the gap space 90 interposed between themselves. In other words, the gap space 90 is defined to extend along the outer peripheral surfaces and upper surface of the inner shell 20.

In addition, a lower end portion 21a of the first shell 21 of the inner shell 20 is coupled to the upper surface 75 of the upper yoke 72 of the yoke 70 via the coupling portion 5 as shown in FIG. 3. The coupling portion 5 is mechanically connected, by brazing, for example, to the lower end portion 21a of the first shell 21. In addition, the coupling portion 5 is also mechanically connected, by brazing, for example, to the upper surface 75 of the upper yoke 72.

A hermetically sealed space 93 is defined inside the upper shell 11 of the outer shell 10. The hermetically sealed space 93 is surrounded with the inner surfaces (including the top surface and inner peripheral surfaces) of the first shell 21 of the inner shell 20 and the upper surface 75 of the upper yoke 72 of the yoke 70. That is to say, the upper yoke 72 of the yoke 70 is arranged to be located under the second shell 22 of the inner shell 20 and to close the opening of the first shell 21 of the inner shell 20.

The shaft 41 is attached to the moving iron core 40. The shaft 41 has the shape of a bar. The shaft 41 is inserted into the sixth through hole 14h of the moving iron core 40 and fixed to the moving iron core 40. In addition, the shaft 41 moves up and down inside the fifth through hole 14g of the upper yoke 72. An upper end portion of the shaft 41 is located inside the hermetically sealed space 93 over the upper surface 75 of the upper yoke 72. The spring bearing 6 is attached to the upper end portion of the shaft 41. The contact pressure spring 8 is fixed to the spring bearing 6. The contact pressure spring 8 is a coiled spring. The contact pressure spring 8 is a spring provided to ensure contact pressure between the moving armature 50 and the pair of fixed terminals 61, 62 (namely, the first fixed terminal 61 and the second fixed terminal 62). The contact pressure spring 8 is fixed to the spring bearing 6 such that the direction in which the contact pressure spring 8 expands and compresses is aligned with the direction in which the shaft 41 moves up and down (i.e., the first direction D1). That is to say, the lower end portion of the contact pressure spring 8 is fixed to the spring bearing 6. The moving armature 50 is mounted onto the upper end portion of the contact pressure spring 8 via the holder 7. That is to say, the contact pressure spring 8 is interposed between the holder 7 and the spring bearing 6. The holder 7 holds the moving armature 50. The moving armature 50 is located in the hermetically sealed space 93. That is to say, the inner shell 20 houses the moving armature 50 inside. In addition, a pair of guides 1a, 1b (refer to FIG. 4) are fixed to the spring bearing 6. The pair of guides 1a, 1b are fixed onto the spring bearing 6 to clamp the holder 7 from both sides in the forward/backward direction (i.e., the third direction D3) defined with respect to the moving armature 50.

The return spring 9 is interposed between the upper yoke 72 and the moving iron core 40. The return spring 9 is a coiled spring. The return spring 9 brings, when the coil 30 is not energized, the moving iron core 40 down to return the moving iron core 40 to its original position. The spring constant of the return spring 9 is larger than the spring constant of the contact pressure spring 8. The return spring 9 is arranged to surround the shaft 41. In other words, the shaft 41 is inserted into the return spring 9.

The moving armature 50 has the shape of a plate (such as a rectangular plate) as shown in FIG. 3. A material for the moving armature 50 is a material with electrical conductivity (such as copper). The moving armature 50 includes a first moving contact 51 and a second moving contact 52. The first moving contact 51 is provided on the upper surface of the moving armature 50 to be located on a left part of the moving armature 50 in the rightward/leftward direction (i.e., the second direction D2). The second moving contact 52 is provided on the upper surface of the moving armature 50 to be located on a right part of the moving armature 50 in the rightward/leftward direction.

The first fixed terminal 61 has the shape of a bottomed cylinder (e.g., a bottomed circular cylinder). A material for the first fixed terminal 61 is a material with electrical conductivity (such as copper). The first fixed terminal 61 is inserted into the first through hole 14a of the ceiling portion 13 of the upper shell 11 of the outer shell 10 and is mounted to the upper shell 11 to face the first moving contact 51 of the moving armature 50. In addition, the first fixed terminal 61 is also inserted into the seventh through hole 14c of the ceiling portion 23 of the first shell 21 of the inner shell 20 and is mounted to the first shell 21 to face the first moving contact 51 of the moving armature 50. The first fixed terminal 61 includes a first fixed contact 63. The first fixed contact 63 is provided on a part, facing the first moving contact 51 of the moving armature 50, of the first fixed terminal 61.

The second fixed terminal 62 has the shape of a bottomed cylinder (e.g., a bottomed circular cylinder). A material for the second fixed terminal 62 is a material with electrical conductivity (such as copper). The second fixed terminal 62 is inserted into the second through hole 14b of the ceiling portion 13 of the upper shell 11 of the outer shell 10 and is mounted to the upper shell 11 to face the second moving contact 52 of the moving armature 50. In addition, the second fixed terminal 62 is also inserted into the eighth through hole 14d of the ceiling portion 23 of the first shell 21 of the inner shell 20 and is mounted to the first shell 21 to face the second moving contact 52 of the moving armature 50. The second fixed terminal 62 includes a second fixed contact 64. The second fixed contact 64 is provided on a part, facing the second moving contact 52 of the moving armature 50, of the second fixed terminal 62.

That is to say, the pair of fixed terminals 61, 62 are mounted onto the ceiling portion 13 of the upper shell 11 of the outer shell 10 to be arranged side by side on the upper shell 11 in the rightward/leftward direction (i.e., in the second direction D2). In addition, the pair of fixed terminals 61, 62 are mounted onto the ceiling portion 23 of the first shell 21 of the inner shell 20 to be arranged side by side on the first shell 21 in the rightward/leftward direction (i.e., in the second direction D2).

An upper end portion of the first fixed terminal 61 is located over the upper surface of the upper shell 11 of the outer shell 10. An upper end portion of the second fixed terminal 62 is located over the upper surface of the upper shell 11 of the outer shell 10. A lower end portion (i.e., bottom portion) of the first fixed terminal 61 is located in the hermetically sealed space 93 of the inner shell 20 to face the first moving contact 51 of the moving armature 50. A lower end portion (i.e., bottom portion) of the second fixed terminal 62 is located in the hermetically sealed space 93 of the inner shell 20 to face the second moving contact 52 of the moving armature 50. The moving armature 50 is disposed under the first fixed terminal 61 and the second fixed terminal 62 to come into contact with the first fixed terminal 61 and the second fixed terminal 62 when moving upward.

The pair of permanent magnets 4a, 4b are fixed onto the outer peripheral surfaces of the first shell 21 of the inner shell 20. More specifically, a first permanent magnet 4a belonging to the pair of permanent magnets 4a, 4b is fixed onto an outer left side surface of the first shell 21 in the rightward/leftward direction (i.e., the second direction D2). A second permanent magnet 4b belonging to the pair of permanent magnets 4a, 4b is fixed onto an outer right side surface of the first shell 21 in the rightward/leftward direction. In short, the pair of permanent magnets 4a, 4b are arranged between the outer peripheral surfaces of the first shell 21 of the inner shell 20 and the inner peripheral surfaces of the upper shell 11 of the outer shell 10. The first permanent magnet 4a has the shape of a plate (such as a rectangular plate). The second permanent magnet 4b has the shape of a plate (such as a rectangular plate).

The pair of permanent magnets 4a, 4b are arranged outside of the pair of fixed terminals 61, 62 in the direction in which the pair of fixed terminals 61, 62 are arranged side by side (i.e., the rightward/leftward direction defined with respect to the first shell 21). In addition, the pair of permanent magnets 4a, 4b are arranged outside of the moving armature 50 in the direction in which the pair of fixed terminals 61, 62 are arranged side by side. That is to say, the pair of permanent magnets 4a, 4b are arranged to interpose the pair of fixed terminals 61, 62 and the moving armature 50 between themselves in the rightward/leftward direction defined with respect to the first shell 21.

Furthermore, the pair of permanent magnets 4a, 4b are arranged such that their side surfaces with mutually different magnetic polarities face each other. For example, as for the first permanent magnet 4a, one side surface thereof on the right side in the rightward/leftward direction defined with respect to the outer shell 10 has S-pole and the other side surface thereof on the left side in the rightward/leftward direction defined with respect to the outer shell 10 has N-pole. On the other hand, as for the second permanent magnet 4b, one side surface thereof on the right side in the rightward/leftward direction defined with respect to the outer shell 10 has S-pole and the other side surface thereof on the left side in the rightward/leftward direction defined with respect to the outer shell 10 has N-pole. That is to say, the first permanent magnet 4a has its S-pole part facing toward the second permanent magnet 4b. The second permanent magnet 4b has its N-pole part facing toward the first permanent magnet 4a. Therefore, the pair of permanent magnets 4a, 4b generates a magnetic field between the pair of fixed contacts 63, 64 and the pair of moving contacts 51, 52. This allows the electromagnetic relay A1 to remove, using the Lorentz force produced in response to the magnetic field generated by the pair of permanent magnets 4a, 4b, the arc discharge generated between the pair of fixed contacts 63, 64 and the pair of moving contacts 51, 52 when the moving armature 50 is brought away from the pair of fixed terminals 61, 62. Note that the number of the permanent magnets 4a, 4b provided does not have to be two but may also be four or more. That is to say, the number of the permanent magnets 4a, 4b provided only needs to be an even number.

The gap space 90 defined between the outer surfaces of the first shell 21 of the inner shell 20 and the inner surfaces of the upper shell 11 of the outer shell 10 is filled with the first filling material 81. That is to say, the first filling material 81 fills the gap between the inner shell 20 and the outer shell 10.

A material for the first filling material 81 may be a resin material. Examples of the resin material include a urethane resin, an epoxy resin, and a silicone resin. The first filling material 81 is thermally connected to the upper shell 11 of the outer shell 10. In addition, the first filling material 81 is also thermally connected to the first shell 21 of the inner shell 20. It is preferable that the first filling material 81 have a lower heat conductivity (thermal conductivity) than the inner shell 20 and a higher heat conductivity (thermal conductivity) than the outer shell 10. Thus, the electromagnetic relay A1 allows the heat to be dissipated more efficiently out of the inner shell 20 than in a situation where an air layer is formed between the inner shell 20 and the outer shell 10.

In this electromagnetic relay A1, as the moving iron core 40 moves up and down, the shaft 41 and the moving armature 50 also move up and down accordingly. That is to say, the moving iron core 40 moves upward to bring the moving armature 50 up. The moving iron core 40 moves downward to bring the moving armature 50 down. In this electromagnetic relay A1, causing the moving armature 50 to move upward brings the upper surface of the moving armature 50 into contact with the pair of fixed terminals 61, 62, thus making the pair of fixed terminals 61, 62 electrically conductive with each other (i.e., turning the contact device 2 ON). On the other hand, in this electromagnetic relay A1, causing the moving armature 50 to move downward brings the upper surface of the moving armature 50 out of contact with the pair of fixed terminals 61, 62, thus making the pair of fixed terminals 61, 62 electrically nonconductive with each other (i.e., turning the contact device 2 OFF).

In this electromagnetic relay A1, heat is generated, for example, when the coil 30 is energized and when energization and arc discharge are produced between the pair of fixed terminals 61, 62 and the moving armature 50. The generation of such heat causes an increase in the temperatures of respective members inside the outer shell 10. In the electromagnetic relay A1, the first filling material 81 fills the gap space 90 between the inner shell 20 and the outer shell 10 and is in contact with the outer surfaces of the inner shell 20. On the other hand, the inner surfaces of the inner shell 20 face the hermetically sealed space 93. That is to say, the outer surfaces of the inner shell 20 are in contact with the first filling material 81 and the inner surfaces of the inner shell 20 face the hermetically sealed space 93. In this case, the temperature of the first filling material 81 tends to be higher than the temperature in the hermetically sealed space 93 due to the generation of the heat, for example. An excessive difference in temperature between the inner and outer surfaces of the inner shell 20 due to a steep increase in the temperature of the first filling material 81 with respect to the temperature of the inner shell 20 would cause some inconveniences such as fractures and cracks to the inner shell 20 owing to a difference in coefficient of thermal expansion between the outer and inner surfaces of the inner shell 20. Among other things, the lower end portion 21a of the first shell 21 of the inner shell 20 and the second shell 22 of the inner shell 20 are so close to the upper yoke 72 of the yoke 70 that heat may be transferred to the inner shell 20 via the yoke 70.

To avoid such inconveniences, in the electromagnetic relay A1 according to this embodiment, the first filling material 81 fills the gap space 90 to a level higher than the lower surface 73 of the yoke 70 (e.g., the upper yoke 72 in this embodiment) as shown in FIG. 1. In other words, the lower surface 81a of the first filling material 81 in the gap space 90 is located above the lower surface 73 of the upper yoke 72 of the yoke 70. In short, the level of the lower surface 81a of the first filling material 81 is higher than that of the lower surface 73 of the upper yoke 72 of the yoke 70.

Furthermore, the first filling material 81 fills the gap space 90 to a level higher than the upper surface 75 of the upper yoke 72 of the yoke 70. In other words, the lower surface 81a of the first filling material 81 in the gap space 90 is located above the upper surface 75 of the upper yoke 72 of the yoke 70.

A first gap 91 (refer to FIG. 1) is left between the side surfaces 74 of the upper yoke 72 of the yoke 70 and the inner surfaces of the outer shell 10. That is to say, the first gap 91 is not filled with the first filling material 81, and the first filling material 81 does not cover any of the side surfaces 74 and lower surface 73 of the upper yoke 72 of the yoke 70. In other words, the first filling material 81 is out of contact with the side surfaces 74 and lower surface 73 of the upper yoke 72 of the yoke 70.

A second gap 92 (refer to FIG. 1) is left between the first filling material 81 and the upper surface 75 of the upper yoke 72 of the yoke 70. Specifically, the second gap 92 not filled with the first filling material 81 is left over the upper surface 75 of the upper yoke 72 in the gap space 90. That is to say, the first filling material 81 fills a part of the gap space 90 over the second gap 92.

In the electromagnetic relay A1 according to this embodiment, the first filling material 81 fills the gap space 90 to a level higher than the lower surface 73 of the upper yoke 72 of the yoke 70 and the lower surface 81a of the first filling material 81 is located above the lower surface 73 of the upper yoke 72. That is to say, the first filling material 81 does not fill any part of the gap space 90 under the lower surface 73 of the upper yoke 72. This allows the electromagnetic relay A1 to reduce the transfer of the heat generated by the yoke 70 to the first filling material 81, thus reducing an increase in the temperature of the first filling material 81. Consequently, the electromagnetic relay A1 may efficiently transfer the heat of the inner shell 20 to the first filling material 81. Such an electromagnetic relay A1 may reduce the difference in temperature between the inner and outer surfaces of the inner shell 20, thereby reducing the chances of causing inconveniences such as fractures and cracks to the inner shell 20.

In particular, the lower surface 81a of the first filling material 81 is located above the lower surface 73 of the upper yoke 72 of the yoke 70. This further reduces the transfer of the heat generated by the yoke 70 to the first filling material 81, thus reducing an increase in the temperature of the first filling material 81. This allows the electromagnetic relay A1 to reduce the chances of causing inconveniences such as fractures and cracks to the inner shell 20 by reducing the difference in temperature between the inner and outer surfaces of the inner shell 20.

### Second Embodiment

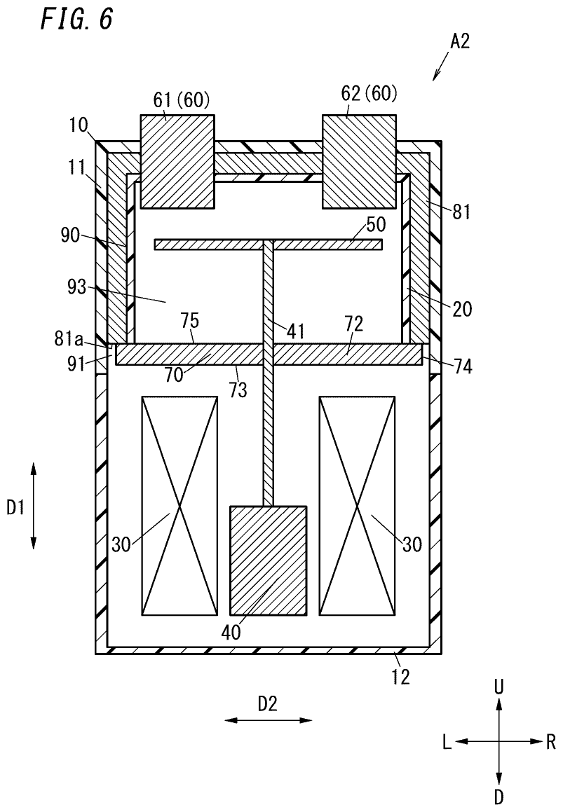

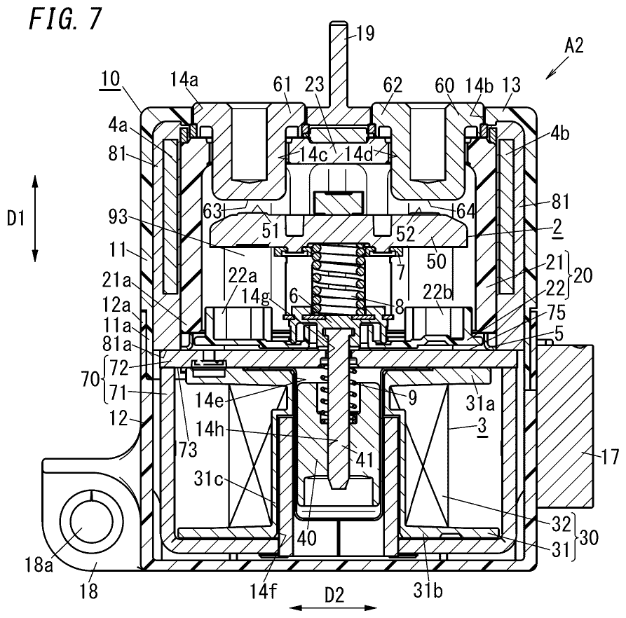

In an electromagnetic relay A2 according to a second embodiment, the lower surface 81a of the first filling material 81 reaches a different level as shown in FIGS. 6 and 7, which is a difference from the electromagnetic relay A1 according to the first embodiment. In the following description, any constituent element of the electromagnetic relay A2 according to this second embodiment, having the same function as a counterpart of the electromagnetic relay A1 according to the first embodiment described above (refer to FIGS. 1-5), will be designated by the same reference numeral as that counterpart's, and description thereof will be omitted herein.

The first filling material 81 is in contact with the upper surface 75 of the upper yoke 72 of the yoke 70 as shown in FIGS. 6 and 7. In other words, the lower surface 81a of the first filling material 81 in the gap space 90 is in contact with the upper surface 75 of the upper yoke 72 of the yoke 70. In short, the lower surface 81a of the first filling material 81 is level with the upper surface 75 of the upper yoke 72 of the yoke 70 and the first filling material 81 fills the gap space 90 to reach the upper surface 75 of the upper yoke 72 of the yoke 70.

In addition, the first gap 91 left between the side surfaces 74 of the upper yoke 72 of the yoke 70 and the inner surfaces of the outer shell 10 is not filled with the first filling material 81 and the first filling material 81 does not cover any of the side surfaces 74 and the lower surface 73 of the upper yoke 72 of the yoke 70 as shown in FIG. 6. In other words, the first filling material 81 is out of contact with any of the side surfaces 74 and lower surface 73 of the upper yoke 72 of the yoke 70.

In addition, the first filling material 81 also fills the gap space 90 defined to extend upward from the upper surface 75 of the upper yoke 72 of the yoke 70. More specifically, the first filling material 81 fills the gap space 90 defined between the outer surfaces (including the upper surface and the outer peripheral surfaces) of the first shell 21 of the inner shell 20, the inner surfaces (including the top surface and the inner peripheral surfaces) of the upper shell 11 of the outer shell 10, and the upper surface 75 of the upper yoke 72 of the yoke 70. That is to say, in this electromagnetic relay A2, the second gap 92 (refer to FIG. 1) of the electromagnetic relay A1 according to the first embodiment is filled with the first filling material 81.

Thus, the electromagnetic relay A2 according to the second embodiment allows the first filling material 81 to fill a larger percentage of the gap space 90 than the electromagnetic relay A1 according to the first embodiment does, thus reducing the chances of the first filling material 81 being thermally saturated and thereby allowing the heat of the inner shell 20 to be transferred to the first filling material 81 even more efficiently.

### Third Embodiment

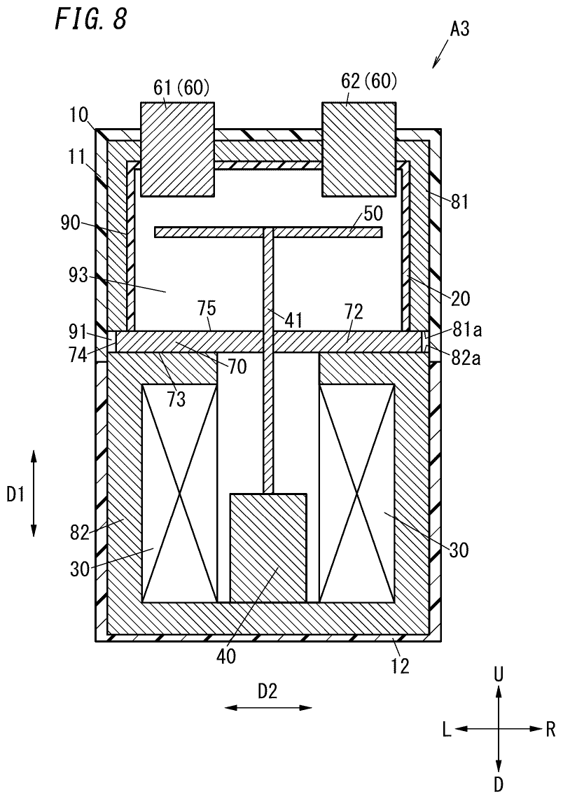

An electromagnetic relay A3 according to a third embodiment further includes a second filling material 82 as shown in FIG. 8, which is a difference from the electromagnetic relay A2 according to the second embodiment. In the following description, any constituent element of the electromagnetic relay A3 according to this third embodiment, having the same function as a counterpart of the electromagnetic relay A2 according to the second embodiment described above (refer to FIGS. 6 and 7), will be designated by the same reference numeral as that counterpart's, and description thereof will be omitted herein.

The electromagnetic relay A3 further includes the second filling material 82 as shown in FIG. 8. The second filling material 82 may be a resin material. Examples of the resin material include a urethane resin, an epoxy resin, and a silicone resin. The first filling material 81 and the second filling material 82 may have the same composition or different compositions, whichever is appropriate.

The second filling material 82 fills the lower shell 12 of the outer shell 10. Specifically, the second filling material 82 fills the space surrounding the coil 30 inside the lower shell 12 and the upper surface 82a of the second filling material 82 in the upward/downward direction (i.e., the first direction D1) defined with respect to the outer shell 10 is in contact with the lower surface 73 of the upper yoke 72 of the yoke 70. The second filling material 82 is thermally connected to the lower shell 12 of the outer shell 10. In addition, the second filling material 82 is also thermally connected to the coil 30.

The lower surface 81a of the first filling material 81 is in contact with the upper surface 75 of the upper yoke 72 of the yoke 70. That is to say, the lower surface 81a of the first filling material 81 and the upper surface 82a of the second filling material 82 are spaced from each other by the thickness of the upper yoke 72 of the yoke 70. That is to say, the lower surface 81a of the first filling material 81 and the upper surface 82a of the second filling material 82 are out of contact with each other. It is preferable that the second filling material 82 have a lower heat conductivity (thermal conductivity) than the inner shell 20 and a higher heat conductivity (thermal conductivity) than the outer shell 10. Thus, the electromagnetic relay A3 allows the heat (such as the heat generated by the coil 30) to be dissipated more efficiently out of the outer shell 10 than in a situation where no second filling material 82 is provided (e.g., a situation where an air layer is formed between the lower shell 12 of the outer shell 10 and the coil 30).

Thus, the electromagnetic relay A3 has a configuration in which the lower shell 12 of the outer shell 10 is filled with the second filling material 82 and the lower surface 81a of the first filling material 81 and the upper surface 82a of the second filling material 82 are out of contact with each other. Thus, the electromagnetic relay A3 may reduce the transfer of heat between the first filling material 81 and the second filling material 82, thus reducing the chances of causing inconveniences to the electromagnetic relay A3. Among other things, this electromagnetic relay A3 reduces the transfer of heat from the first filling material 81 that tends to have a high temperature to the second filling material 82, thus reducing the thermal impact on the coil 30 and other members.

Optionally, the lower surface 81a of the first filling material 81 does not have to be in contact with the upper surface 75 of the upper yoke 72 of the yoke 70. That is to say, the lower surface 81a of the first filling material 81 may be located at a higher level than the upper surface 75 of the upper yoke 72 of the yoke 70 as in the electromagnetic relay A1 according to the first embodiment described above.

### Fourth Embodiment

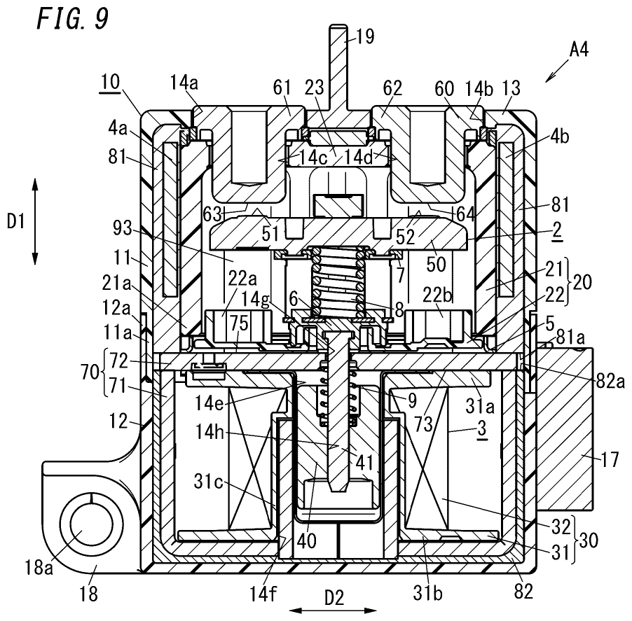

In an electromagnetic relay A4 according to a fourth embodiment, the second filling material 82 is disposed differently as shown in FIG. 9, which is a difference from the electromagnetic relay A3 according to the third embodiment. In the following description, any constituent element of the electromagnetic relay A4 according to this fourth embodiment, having the same function as a counterpart of the electromagnetic relay A3 according to the third embodiment described above (refer to FIG. 8), will be designated by the same reference numeral as that counterpart's, and description thereof will be omitted herein.

The second filling material 82 fills the space inside the lower shell 12 of the outer shell 10 as shown in FIG. 9. In addition, the second filling material 82 also fills the space surrounding the lower yoke 71 of the yoke 70 inside the lower shell 12 of the outer shell 10. That is to say, the upper surface 82a of the second filling material 82 is out of contact with the lower surface 73 of the upper yoke 72 of the yoke 70. The second filling material 82 is thermally connected to the lower shell 12 of the outer shell 10. In addition, the second filling material 82 is also thermally connected to the lower yoke 71 of the yoke 70.

The lower surface 81a of the first filling material 81 and the upper surface 82a of the second filling material 82 are spaced from each other by the thickness of the upper yoke 72 of the yoke 70. That is to say, the lower surface 81a of the first filling material 81 and the upper surface 82a of the second filling material 82 are out of contact with each other.

Thus, the electromagnetic relay A4 has a configuration in which the second filling material 82 fills the space inside the lower shell 12 of the outer shell 10 and the lower surface 81a of the first filling material 81 and the upper surface 82a of the second filling material 82 are out of contact with each other. Thus, the electromagnetic relay A4 may reduce the transfer of heat between the first filling material 81 and the second filling material 82, thus reducing the chances of causing inconveniences to the electromagnetic relay A4. Among other things, this electromagnetic relay A4 reduces the transfer of heat from the first filling material 81 that tends to have a high temperature to the second filling material 82, thus reducing the thermal impact on the coil 30 and other members.

### Aspects

The foregoing description provides specific implementations for the following aspects of the present disclosure.

An electromagnetic relay (A1; A2; A3; A4) according to a first aspect of the exemplary embodiments includes a fixed terminal (60), a moving armature (50), an inner shell (20), a yoke (72), an outer shell (10), and a first filling material (81). The moving armature (50) is arranged under the fixed terminal (60) to contact with the fixed terminal (60). The inner shell (20) houses the moving armature (50) inside and a lower surface of the inner shell (20) has an opening. The yoke (72) is arranged under the inner shell (20) to close the opening of the inner shell (20). The outer shell (10) houses the inner shell (20) inside. The first filling material (81) is arranged to fill a gap space between the inner shell (20) and the outer shell (10). The first filling material (81) fills the gap space to a level higher than a lower surface (73) of the yoke (72).

In this electromagnetic relay (A1; A2; A3; A4), the first filling material (81) fills the gap space to a level higher than the lower surface (73) of the yoke (72), thus reducing the transfer of the heat generated by the yoke (72) to the first filling material (81) and thereby reducing an increase in the temperature of the first filling material (81) that fills the gap space inside the outer shell (10). This allows the electromagnetic relay (A1; A2; A3; A4) to efficiently transfer the heat of the inner shell (20) to the first filling material (81).

In an electromagnetic relay (A1; A2; A3; A4) according to a second aspect of the exemplary embodiments, which may be implemented in conjunction with the first aspect, a lower surface (81a) of the first filling material (81) is preferably located above the lower surface (73) of the yoke (72).

This electromagnetic relay (A1; A2; A3; A4) may reduce an increase in the temperature of the first filling material (81) that fills the gap space inside the outer shell (10). This allows the electromagnetic relay (A1; A2; A3; A4) to efficiently transfer the heat of the inner shell (20) to the first filling material (81).

In an electromagnetic relay (A1; A2; A3; A4) according to a third aspect of the exemplary embodiments, which may be implemented in conjunction with the first or second aspect, a first gap (91) is preferably left between a side surface (74) of the yoke (72) and an inner surface of the outer shell (10).

In this electromagnetic relay (A1; A2; A3; A4), the first filling material (81) is out of contact with the side surface (74) of the yoke (72), thus further reducing the transfer of the heat generated by the yoke (72) to the first filling material (81) and thereby more efficiently transferring the heat of the inner shell (20) to the first filling material (81).

In an electromagnetic relay (A1; A2; A3; A4) according to a fourth aspect of the exemplary embodiments, which may be implemented in conjunction with any one of the first to third aspects, the first filling material (81) preferably fills the gap space to a level higher than an upper surface (75) of the yoke (72).

This electromagnetic relay (A1; A2; A3; A4) further reduces the transfer of the heat generated by the yoke (72) to the first filling material (81) and thereby allows the heat of the inner shell (20) to be transferred more efficiently to the first filling material (81).

In an electromagnetic relay (A2; A3; A4) according to a fifth aspect of the exemplary embodiments, which may be implemented in conjunction with any one of the first to fourth aspects, the first filling material (81) is preferably in contact with an upper surface (75) of the yoke (72).

This electromagnetic relay (A2; A3; A4) may increase the amount of the first filling material (81) that fills the gap space, thus making the first filling material (81) thermally saturated much less easily. This allows the heat of the inner shell (20) to be transferred to the first filling material (81) even more efficiently.

In an electromagnetic relay (A1) according to a sixth aspect of the exemplary embodiments, which may be implemented in conjunction with any one of the first to fourth aspects, a second gap (92) is preferably left between the first filling material (81) and an upper surface (75) of the yoke (72).

In this electromagnetic relay (A1), the first filling material (81) is out of contact with the upper surface (75) of the yoke (72), which further reduces the transfer of the heat generated by the yoke (72) to the first filling material (81) and thereby allows the heat of the inner shell (20) to be transferred to the first filling material (81) more efficiently.

An electromagnetic relay (A3; A4) according to a seventh aspect of the exemplary embodiments, which may be implemented in conjunction with any one of the first to sixth aspects, preferably further includes a moving iron core (40), a coil (30), and a second filling material (82). The moving iron core (40) moves upward to bring the moving armature (50) up and moves downward to bring the moving armature (50) down. The coil (30) causes the moving iron core (40) to move either upward or downward. The outer shell (10) includes: an upper shell (11) housing the inner shell (20) inside; and a lower shell (12) housing the moving iron core (40) and the coil (30) inside and filled with the second filling material (82). A lower surface (81a) of the first filling material (81) is out of contact with an upper surface (82a) of the second filling material (82).

This electromagnetic relay (A3; A4) has a configuration in which the space inside the lower shell (12) is filled with the second filling material (82) to make the lower surface (81a) of the first filling material (81) out of contact with the upper surface (82a) of the second filling material (82). This reduces the transfer of heat between the first filling material (81) and the second filling material (82) and reduces the chances of causing any inconvenience to the electromagnetic relay (A3; A4). In particular, this electromagnetic relay (A3; A4) may significantly reduce the transfer of heat from the first filling material (81), which tends to have a rather high temperature, to the second filling material (82), thus reducing thermal impact on the coil (30) and other members.

In an electromagnetic relay (A1; A2; A3; A4) according to an eighth aspect of the exemplary embodiments, which may be implemented in conjunction with any one of the first to seventh aspects, the first filling material (81) preferably has a lower thermal conductivity than the inner shell (20) and has a higher thermal conductivity than the outer shell (10).

This electromagnetic relay (A1; A2; A3; A4) allows the heat to be dissipated more efficiently out of the inner shell (20) than in a situation where an air layer is formed between the inner shell (20) and the outer shell (10).

### REFERENCE SIGNS LIST

10 Outer Shell
11 Upper Shell
12 Lower Shell
20 Inner Shell
30 Coil
40 Moving Iron Core
50 Moving Armature
60 Fixed Terminal
72 Upper Yoke (Yoke)
73 Lower Surface
74 Side Surface
75 Upper Surface
81 First Filling Material
81a Lower Surface
82 Second Filling Material
82a Upper Surface
91 First Gap
92 Second Gap
A1 Electromagnetic Relay
A2 Electromagnetic Relay
A3 Electromagnetic Relay
A4 Electromagnetic Relay

1. An electromagnetic relay comprising:
a fixed terminal;
a moving armature arranged under the fixed terminal to contact with the fixed terminal;
an inner shell housing the moving armature inside, a lower surface of the inner shell having an opening;
a yoke arranged under the inner shell to close the opening of the inner shell;
an outer shell housing the inner shell inside; and
a first filling material arranged to fill a gap space between the inner shell and the outer shell,
the first filling material filling the gap space to a level higher than a lower surface of the yoke.

2. The electromagnetic relay of claim 1, wherein
a lower surface of the first filling material is located above the lower surface of the yoke.

3. The electromagnetic relay of claim 1, wherein
a first gap is left between a side surface of the yoke and an inner surface of the outer shell.

4. The electromagnetic relay of claim 1, wherein
the first filling material fills the gap space to a level higher than an upper surface of the yoke.

5. The electromagnetic relay of claim 1, wherein
the first filling material is in contact with an upper surface of the yoke.

6. The electromagnetic relay of claim 1, wherein
a second gap is left between the first filling material and an upper surface of the yoke.

7. The electromagnetic relay of claim 1, further comprising:
a moving iron core configured to move upward to bring the moving armature up and move downward to bring the moving armature down;
a coil configured to cause the moving iron core to move either upward or downward; and
a second filling material, wherein
the outer shell includes:
an upper shell housing the inner shell inside; and
a lower shell housing the moving iron core and the coil inside and filled with the second filling material, and
a lower surface of the first filling material is out of contact with an upper surface of the second filling material.

8. The electromagnetic relay of claim 1, wherein
the first filling material has a lower thermal conductivity than the inner shell and has a higher thermal conductivity than the outer shell.
